(19) United States
(12) Patent Application Publication
(10) Pub. No.: US 2019/0139423 A1
(43) Pub. Date: May 9, 2019

(54) METHOD AND ELECTRONIC DEVICE FOR FILTERING TRAFFIC INFORMATION IN AN AIRPORT DOMAIN, ASSOCIATED COMPUTER PROGRAM

(71) Applicant: THALES, Courbevoie (FR)

(72) Inventors: Olivier FREROTTE, Toulouse (FR); Philippe DURUT, Merignac (FR)

(21) Appl. No.: 16/179,996

(22) Filed: Nov. 4, 2018

(30) Foreign Application Priority Data
Nov. 6, 2017 (FR) 1701137

(51) Int. Cl. G08G 5/00; G08G 5/02

(52) U.S. Cl. CPC G08G 5/0026; G08G 5/02; G08G 5/0082

(57) ABSTRACT

This method of filtering traffic information in an airport domain is implemented by an electronic device and comprises acquisition of runway information; acquisition of traffic information; and filtering the acquired traffic information, wherein the filtering comprises identifying each traffic element positioned within a runway vicinity.

The filtering comprises, for each runway, determination of a reference frame change operation from a current reference frame to a new reference frame in which the respective runway is oriented vertically or horizontally; calculating the runway vicinity in the new reference frame via the reference frame change operation; calculating each traffic element position in the new reference frame via the reference frame change operation; and comparison, in the new reference frame, of each traffic element position, with the runway vicinity.

### CROSS-REFERENCE TO RELATED APPLICATIONS

This application is a U.S. non-provisional application claiming the benefit of French Application No. 17 01137, filed on Nov. 6, 2017, which is incorporated herein by reference in its entirety.

### FIELD

The present invention relates to a method for filtering traffic information in an airport domain, wherein the method is implemented by an electronic device.

The invention also relates to a non-transitory computer-readable medium including a computer program comprising software instructions which, when executed by a computer, implement such a method.

The invention also relates to an electronic device for filtering traffic information in an airport domain.

Those skilled in the art will understand that the airport domain, also called airport zone, is understood in a broad sense, and corresponds to a volume encompassing a ground area and an air volume up to a predefined altitude above the surface of the ground, such as air volume up to 3000 feet above the airport surface, or up to 1000 feet above the airport surface.

The invention generally relates to all the phases for which the aircraft is inside the airport domain as defined above, such as the ground taxiing phase in the airport domain, the take-off phase until the aircraft reaches the altitude mentioned above, the landing phase, or the approach phase from the above-mentioned threshold altitude. “Taxiing” means a movement of the aircraft in the airport domain, wherein the aircraft is in contact with the ground in the case of an airplane or a drone, or close to the ground in the case of a helicopter.

The invention relates, in particular, to the domain of assistance for taxiing the aircraft in the airport domain and/or for monitoring the taxiing of the aircraft, based on a filtering of traffic information in the airport domain.

### BACKGROUND

Document U.S. Pat. No. 8,600,651 B2 discloses a computer-implemented method of filtering traffic information for display on a screen, wherein the traffic information is filtered independently of the runways and the architecture of the airport, while taking into account a criterion of convergence of the traffic information.

Document U.S. Pat. No. 8,786,467 B2 relates to a method of displaying traffic information on a mobile map presented in the cockpit of an airplane located on an airport runway, wherein this method makes it possible to identify traffic information associated with traffic elements that are positioned on or near the runways, i.e. within the vicinity of the runways.

Document FR 2 910 681 A1 also relates to the filtering of traffic information, and describes a system for selective reporting of traffic information on an airport traffic map displayed in the cockpit of an aircraft.

However, such a method and device for filtering traffic information in an airport domain represents a significant requirement in terms of computing resources.

### SUMMARY

The object of the invention is to propose a method and a device for filtering traffic information in an airport domain, which are more efficient, particularly in terms of computing resources.

For this purpose, the subject of the invention is a method for filtering traffic information in an airport domain, wherein the method is implemented by an electronic device and comprises:
an acquisition of runway information for each runway of a set of runways of the airport domain;
an acquisition of traffic information, wherein the traffic information comprises the position of each traffic element of a set of traffic elements; and
a filtering of the acquired traffic information, wherein the filtering comprises the identification of each traffic element positioned inside the vicinity of at least one runway of the set of runways,

wherein the filtering comprises, for each runway of the set of runways:
determination of a reference frame change from a current reference frame to a new reference frame, wherein the respective runway is oriented in a vertical or horizontal direction in the new reference frame,
calculation of the runway vicinity in the new reference frame via the determined reference frame change operation,
calculation of the position of each traffic element in the new reference frame via the determined reference frame change operation, and
comparison of each computed traffic element position in the new reference frame, with the calculated runway vicinity, for identification of each traffic element positioned within the vicinity of the respective runway.

The filtering method according to the invention makes it possible to simplify the identification of each traffic element positioned within the vicinity of at least one runway of the airport domain, by determining for each runway of the set of runways, the reference frame change operation allowing movement from the current reference frame to the new reference frame wherein the runway is oriented in the vertical direction, i.e. in the North-South direction, or in the horizontal direction, i.e. the East-West direction, and then calculation of the runway vicinity and each traffic element position in the new reference frame, each time there was a previously determined change of reference frame.

The comparison of each traffic element position in the vicinity of the runway is then simpler to perform in the new reference frame, which facilitates the identification of each traffic element positioned within the vicinity of the runway. Traffic information filtering is then more efficient, with less demand for computing resources.

By “traffic element” is meant any mobile vehicle within the airport domain, wherein this vehicle is, for example, an aeronautical vehicle, such as another aircraft, or a motor vehicle, such as a bus, a truck, or a maintenance vehicle. In view of the above definition of the airport domain, those skilled in the art will understand that when the traffic element is an aeronautical vehicle, then this aeronautical vehicle is, for example, in the taxiing phase, the take-off phase, the landing phase or the approach phase. Each vehicle inside the airport domain is generally equipped with a positioning device in order to identify its position in the airport domain. Alternatively or additionally, the position of each vehicle inside the airport domain may be identified via aerial, radar or satellite observation of the airport domain.

According to other advantageous aspects of the invention, the filtering method comprises one or more of the following characteristics, taken separately or in any technically feasible combination:
the determined reference frame change operation is a rotation operation with a rotation angle as a function of the orientation of the respective runway;
the absolute value of the angle of rotation is equal, modulo 90°, to a course angle with respect to the North of the respective runway;
each runway of the set of runways of the airport domain comprises a runway threshold, and the calculation of the runway vicinity in the new reference frame comprises the calculation of the position of the runway threshold in the new reference frame via the determined reference frame change operation, wherein the runway vicinity is calculated from the runway threshold position in the new reference frame;
each runway vicinity has a first rectangular-shaped runway zone.
each runway vicinity has a second rectangular-shaped runway zone, wherein the second runway zone comprises the first runway zone for the respective runway, wherein each side of the second runway area is substantially parallel to a corresponding side of the first runway;
the determination of a reference frame change operation and/or the calculation of each traffic element position in the new reference frame is performed once for all runways of the set of runways having the same orientation; and
the method further comprises transmitting to an electronic display device and/or an onboard avionic system, such as a device monitoring the identified traffic element(s).

The invention also relates to a non-transitory computer-readable medium including a computer program comprising software instructions which, when executed by a computer, implement a filtering method as defined above.

The invention also relates to an electronic device for filtering traffic information in an airport domain, wherein the electronic device comprises:
a first acquisition module designed to acquire runway information for each runway of a set of runways of the airport domain;
a second acquisition module designed to acquire traffic information, wherein the traffic information comprises the position of each traffic element of a set of traffic elements; and
a filter module designed to filter the acquired traffic information, wherein the filter module is designed to identify each traffic element positioned within the vicinity of at least one runway of a set of runways;

wherein, for each runway of the set of runways, the filter module is designed to:
determine a reference frame change operation, from a current reference frame to a new reference frame, wherein the respective runway is oriented in a vertical or horizontal direction in the new reference frame,
calculate the runway vicinity in the new reference frame via the specified reference frame change operation,
calculate each traffic element position in the new reference frame via the determined reference frame change operation, and
compare each computed traffic element position in the new reference frame with the calculated runway vicinity, for the identification of each traffic element positioned within the vicinity of the respective runway.

### BRIEF DESCRIPTION OF THE DRAWINGS

These features and advantages of the invention will appear more clearly upon reading the description which follows, given solely by way of nonlimiting example, and with reference to the appended drawings, wherein:

FIG. 1 shows a schematic representation of an aircraft equipped with an electronic filtering device according to the invention, and designed to filter traffic information in an airport domain;

FIG. 2 shows a flowchart of a method according to the invention for filtering traffic information in the airport domain, wherein the method is implemented by the electronic device of FIG. 1 and comprises the acquisition of runway information; the acquisition of traffic information, and filtering the acquired traffic information;

FIG. 3 shows a flow chart of the filtering of the traffic information of FIG. 2;

FIG. 4 shows a schematic view illustrating a reference frame change operation from a current reference frame to a new reference frame, wherein the respective runway is oriented in a vertical direction in the new reference frame;

FIG. 5 shows a schematic view illustrating a calculation of the runway vicinity in the new reference frame following the reference frame change operation of FIG. 4; and

FIG. 6 shows a schematic view illustrating a comparison, in the new reference frame, of each traffic element position, with the runway vicinity, for the identification of each traffic element positioned inside the vicinity of the runway.

### DETAILED DESCRIPTION

In the remainder of the description, the expression “substantially equal to” defines a relationship of equality at plus or minus 10%, preferably at plus or minus 5%.

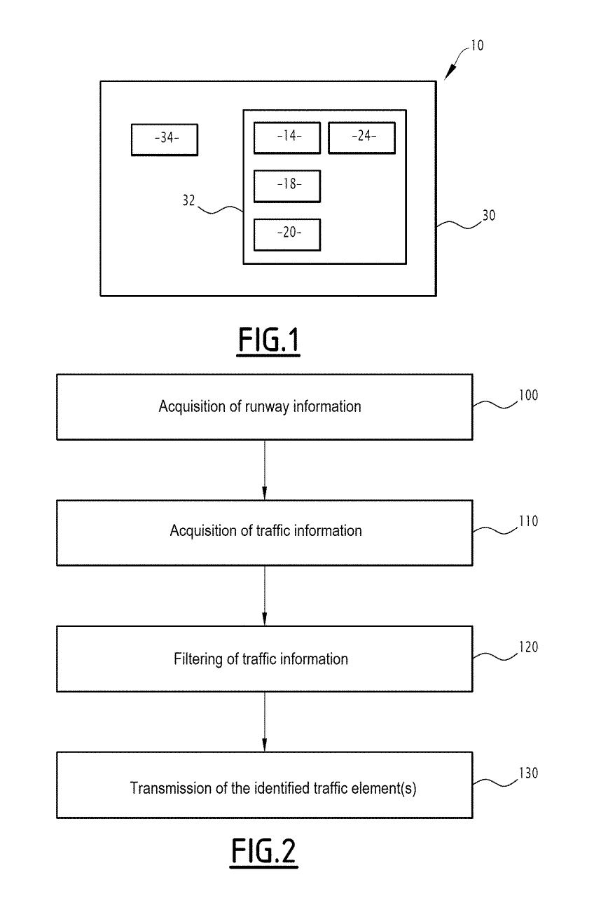

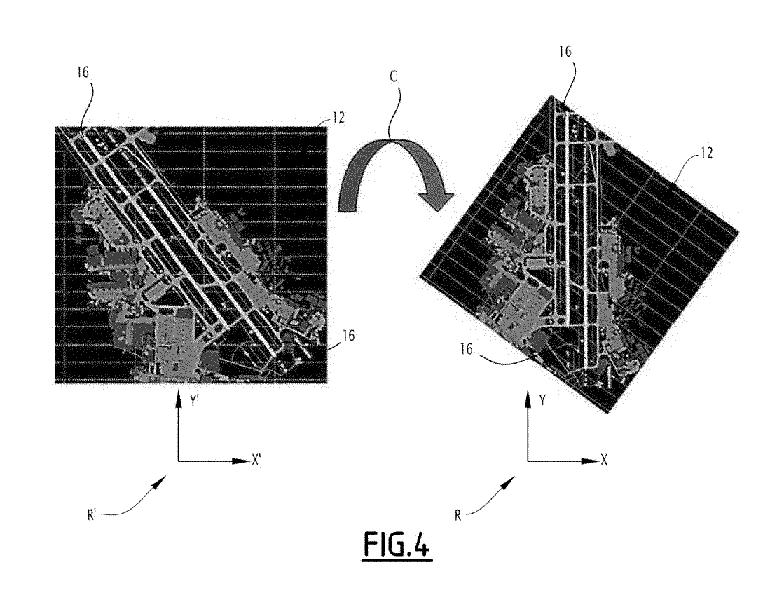

In FIG. 1, the aircraft comprises an electronic filtering device 10 designed to filter traffic information in an airport domain 12, as visible in FIG. 4 to 6.

The aircraft is preferably an airplane. Alternatively, the aircraft may be a helicopter, or a drone.

The aircraft further comprises an electronic display device (not shown) that is designed to display traffic information based on the filtering performed by the electronic filtering device 10.

The aircraft further comprises an electronic monitoring device (not shown) that is designed, in particular, to trigger an alert if the risk of collision with the aircraft is detected, based on the filtering performed by the electronic filtering device 10.

In the example of FIG. 1, the electronic filtering device 10, the electronic display device, and the electronic monitoring device are each avionic device on board the aircraft, for example an onboard tablet, also known as an EFB. (Electronic Flight Bag).

In a variant (not shown), at least one electronic device, or all electronic devices, among the electronic filtering device 10, the electronic display device, and the electronic monitoring device, are electronic devices that are external to the aircraft, such as one or more electronic devices installed on the ground.

The electronic filtering device 10 comprises a first acquisition module 14 designed to acquire runway information for each runway 16 of a set of runways of the airport domain 12, and a second acquisition module 18 designed to acquire traffic information.

The electronic filtering device 10 comprises a filter module 20 designed to filter the acquired traffic information, wherein the filter module 20 is designed to identify each traffic element positioned within the vicinity 22 of at least one runway 16 of all the runways.

The electronic filtering device 10 comprises a transmission module 24 that is designed to transmit to the electronic display device and/or to an onboard avionic system, such as the monitoring device, the identified traffic element(s).

In the example of FIG. 1, the electronic filtering device 10 comprises an information processing unit 30 comprising, for example, a memory 32 associated with a processor 34.

In the example of FIG. 1, the first acquisition module 14, the second acquisition module 18, the filter module 20, and the transmission module 24 are each produced in the form of software executable by the processor 34. The memory 32 is then able to store a first acquisition software designed to acquire runway information, a second acquisition software designed to acquire traffic information, a filtering software designed to filter the acquired traffic information, and a transmission software designed to transmit the identified traffic element(s). The processor 34 of the information processing unit 30 is then able to execute the first acquisition software, the second acquisition software, the filtering software and the transmission software.

In a variant (not shown), the first acquisition module 14, the second acquisition module 18, the filter module 20 and the transmission module 24 are each produced in the form of a programmable logic components, such as an FPGA (Field Programmable Gate Array), or in the form of a dedicated integrated circuit, such as an ASIC (Application Specific Integrated Circuit).

The first acquisition module 14 is designed to acquire runway information for each runway 16, for example from a database of the airport domain 12, such as a database compliant with the ARINC-816 standard.

The first acquisition module 14 is, for example, designed to acquire, from the ICAO (International Civil Aviation Organization) code of the airport in question, and from the ARINC-816-compliant database, such as version 2 of this standard in the example below, also known as ARINC-816-2 and published on 25 Jun. 2012, an amdb-type file. For example, the first acquisition module 14 is designed to identify the amdb-type file to be acquired, from a header file of the database of the adb.bml type, wherein this header file associates the ICAO code of the airport with the corresponding amdb-type file of the database.

The first acquisition module 14 is then designed to acquire, in this airport amdb -type file, the runway information for each runway 16 via a search of the elements of the ‘RunwayElement’ type.

Alternatively, the airport domain database 12 may be a database that is compliant with the ARINC-424 standard. The first acquisition module 14 is, for example, designed to acquire, in the ARINC-424-compliant database, such as version 20 of this standard in the example below, also called ARINC-424-20 and published on 5 Dec. 2011, the runway information for each runway 16 from the ‘AIRPORT ICAO CODE’ and ‘RUNWAY DENT’ fields, respectively corresponding to an identifier of the airport and the name of the runway threshold.

Each runway 16 of the set of runways of the airport domain preferably comprises a runway threshold.

The runway information comprises a position associated with the runway, such as the position of a runway threshold, and an orientation of the runway.

Alternatively, the runway information may comprise two distinct positions associated with the runway, while the orientation of the corresponding runway may be recalculated from these two distinct positions.

The second acquisition module 18 is designed to acquire the traffic information, wherein the traffic information comprises, in particular, the position of each traffic element T1, T2 of a set of traffic elements, in particular the position of the traffic elements T1, T2 located inside the airport domain 12.

The position of each vehicle inside the airport domain is identified via an aerial observation of the airport domain obtained by an aircraft, via a radar observation of the airport domain obtained by a surface radar located inside or near the airport domain, and/or via a satellite observation of the airport domain obtained by a satellite.

The filter module 20 is designed to determine a change of reference frame C for each runway 16 of the set of runways, from a current reference frame R′ to a new reference frame R, wherein the respective runway 16 is oriented in a vertical or horizontal direction in the new reference frame R, as shown in FIG. 4.

The reference frame change operation C is preferably a rotational operation with a rotation angle as a function of an orientation of the respective runway 16. The absolute value of the angle of rotation is equal, modulo 90°, to a course angle with respect to the North of the respective runway 16.

In other words, with the determined reference frame change operation C, the runway 16 in question is oriented along the cardinal points (North-South or East-West) in the new reference frame R.

If we consider X′, Y′ as the coordinates of a point in the old reference frame or current coordinate system R′, and X, Y as the coordinates of this point in the new reference frame R, then the target reference frame change operation C satisfies, for example, the following equations:

X=X′·cos(α)−Y′·sin(α) (1)

Y=X′·sin(α)+Y′·cos(α) (2)

wherein α represents the course angle to the North of the respective runway 16.

Those skilled in the art will understand that, alternatively, the angle used in equations (1) and (2) above for the reference frame change operation C may be, for example, equal to α+90° or to α−90°, when the runway 16 is, in the new reference frame R, oriented in the East/West direction, rather than in the North/South direction.

When the database of the airport domain 12 is a database that is compliant with the ARINC-816 standard, the filter module 20 is, for example, designed to acquire the orientation of the runway 16, by recovering the name of the runway 16 from the ‘idrwy’ attribute of the ‘RunwayElement’, by identifying for each runway 16, a runway threshold name from the ‘idthr’ attribute of the ‘RunwayThreshold’ element or from the ‘thrtype’ attribute of this ‘RunwayThreshold’ element corresponding to an offset runway threshold, and retrieving the course information of the runway 16 from the ‘brngtrue’ attribute for the true heading, or from the ‘brngmag’ attribute for the magnetic heading.

When the airport domain database 12 is a database that Is compliant with the ARINC-424 standard, the filter module 20 is, for example, designed to acquire the orientation of the runway 16 from the ‘Runway’ attribute ‘Runway Magnetic Bearing’ for the runway 16.

The filter module 20 is, for each runway 16 of the set of runways, then designed to calculate each traffic element position T1, T2 in the new reference frame R via the determined reference frame change operation C. For example, the filter module 20 is designed to perform the calculation of the coordinates of each traffic element position T1, T2 in the new reference frame R, by applying the above equations (1) and (2) to the coordinates of each position of the traffic element T1, T2 in the current reference frame R′.

The filter module 20 is, for each runway 16 of the set of runways, designed to calculate the runway vicinity 22 in the new reference frame R via the determined reference frame change operation C.

Each runway vicinity 22 comprises, for example, a first runway zone ZP of rectangular shape, shown in FIG. 5 in the form of a dotted line rectangle. The runway threshold is preferably positioned substantially in the center of a small side, or width, of the first runway zone ZP.

The first runway zone ZP substantially corresponds to the area of the runway 16 in question, including the runway displaced area and the stopway zones. Alternatively, the first runway zone ZP substantially corresponds to the area of the runway 16 in question, without including the runway displaced areas and stopway zones.

For the calculation of the runway vicinity 22 in the new reference frame R, the filter module 20 is, for example, designed to calculate the position of the runway threshold in the new reference frame R by the determined reference frame change operation C, wherein the runway vicinity 22 is then calculated from the position of the runway threshold in the new reference frame R.

When the airport domain database 12 is a database compliant with the ARINC -816 standard, the filter module 20 is, for example, designed to acquire position coordinates of the runway threshold from the attribute ‘point’ of the ‘RunwayThreshold’ element, and then to convert these position coordinates into the new reference frame R via the determined reference frame change operation C, for example by applying the above equations (1) and (2) to the position of the coordinates of the runway threshold.

The filter module 20 is then designed to acquire runway length information for that runway threshold, from the ‘asda’ attribute of the ‘RunwayThreshold’ element, and then to acquire runway width information from the ‘width’ attribute of the ‘RunwayElement’.

The filter module 20 is then designed to calculate the first rectangular runway zone ZP by calculating two first vertices of the rectangle positioned on the abscissa, at a distance equal to half of the runway width acquired, from one side to the other of the runway threshold, and at the same ordinate as the runway threshold in the new reference frame R. The other two vertices of the rectangle forming the first runway zone ZP have abscissa respectively equal to the abscissa of the first two vertices calculated from the rectangle, wherein each has an ordinate equal to the sum of the ordinate of the runway threshold and the runway length acquired.

Alternatively, the lateral distance used to calculate the first runway zone ZP from the runway threshold is strictly greater than half the acquired runway width, so that the first runway zone ZP has a slightly larger area than that strictly corresponding to the runway 16. Alternatively or additionally, the longitudinal distance used to calculate the first runway zone ZP is strictly greater than the acquired runway length, so that the first runway zone ZP has an area that is slightly larger than that strictly corresponding to the runway 16.

When the airport domain database 12 is a database compliant with the ARINC -424 standard, the filter module 20 is, for example, designed to acquire position coordinates of the runway threshold, from the attributes ‘Runway Longitude’ and ‘Runway Latitude’, then to convert these position coordinates into the new reference frame R via the determined reference frame change operation C, for example by applying the above equations (1) and (2) to the position coordinates of the runway threshold.

The filter module 20 is then designed to acquire runway length information for that runway threshold, as the sum of the ‘Runway Length’, ‘Displaced Threshold Distance’ and ‘Stopway’ attributes, and then to acquire runway width information from the ‘Runway Width’ attribute.

The filter module 20 is then designed to calculate the four vertices of the first rectangular-shaped runway zone ZP, in a manner analogous to that previously described in the case of the ARINC-816 standard.

Each runway vicinity 22 preferably further comprises a second runway zone ZPP of rectangular shape as shown in FIG. 5 in the form of a dashed rectangle. The second runway zone ZPP includes the first runway zone ZP for the respective runway 16, wherein each side of the second runway zone ZPP is substantially parallel to a corresponding side of the first runway zone ZP. The second runway zone ZPP is also referred to as the runway zone vicinity, and corresponds to a larger area around the first runway zone ZP.

The second runway zone ZPP has, for example, a wider and/or longer area than the first runway zone ZP of a predefined fixed value. The filter module 20 is, for example, designed to calculate the second runway zone ZPP by adding a predefined distance, such as a distance substantially equal to 60 m, on each side of the first runway zone ZP.

Alternatively, the second runway zone ZPP may have an area that is wider and/or longer than the first runway zone ZP with a value dependent on the architecture of the airport, such as a value depending on the distances of stopping zones to the runway 16, or a value depending on the taxiway distances parallel to the runway 16.

As a further variant, the second runway zone ZPP may have an area that is wider and/or longer than the first runway zone ZP with a value that may be set by the user.

Those skilled in the art will understand that the second runway zone ZPP is, alternatively, an enlargement of the first runway zone ZP with independent lateral magnification values for each side of the first runway zone ZP in question.

The filter module 20 is finally designed to compare, for each runway 16 of the set of runways in the new reference frame R, each traffic element position T1, T2 calculated with the runway vicinity 22 that is calculated in order to identify each traffic element T1, T2 positioned within the vicinity 22 of the respective runway 16.

To determine whether the traffic element T1, T2 in question belongs to the vicinity 22 of the respective runway 16, for example to the first runway area ZP and/or the second runway area ZPP, the filter module 20 is designed to compare, in the new reference frame R, the calculated position of the traffic element T1, T2 in question, i.e. its coordinates, with the coordinates of the sides of the vicinity 22 of the respective runway 16, for example with the coordinates of the sides of the first runway zone ZP or those of the sides of the second runway zone ZPP.

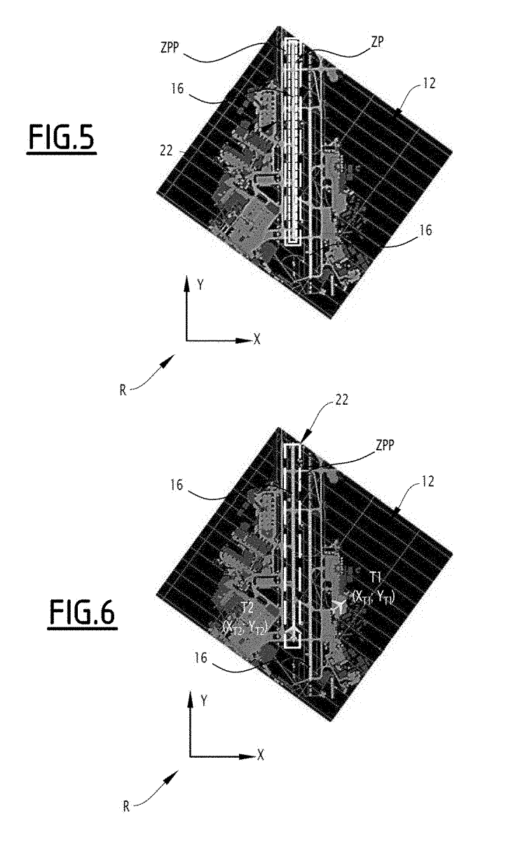

In the example of FIG. 6, once the runway reference frame change operation has been made, the second runway zone ZPP is the zone whose four vertices have coordinates (0; 0), (x_{zpp}; 0), (x_{zpp}; y_{zpp}) and (0; y_{zpp}) in the reference frame R. Then considering the first and second traffic elements T1, T2, at the respective coordinates (x_{T1}; y_{T1}) and (x_{T2}; y_{T2}), the filter module 20 is designed to determine whether the first traffic element T1 is outside the second runway zone ZPP because x_{T1}>x_{ZPP}. Similarly, the filter module 20 is designed to determine whether the second traffic element T2 belongs to the second runway zone ZPP because 0≤x_{T2}≤x_{ZPP} and 0≤y_{T2}≤y_{ZPP}.

Optionally and additionally, the filter module 20 is designed to associate with the identified traffic element, information of affiliation to the vicinity 22 of the respective runway 16, such as information of affiliation to the first runway zone ZP and/or to the second runway zone ZPP. The information of affiliation to the first runway zone ZP will allow, for example, the following runways 16 to be analyzed, and to no longer consider the traffic elements having previously been taken into account for the runway 16, such as information of affiliation to the first runway zone ZP. The information of affiliation to the second runway zone ZPP will make it possible to look at the traffic elements with information of affiliation to the second runway zone ZPP for a runway 16 that was previously only taken into account for a possible affiliation to the first runway zone ZP for another runway 16 (particular case of a traffic element in the second runway zone ZPP for one runway 16 and in the first runway zone ZP for another runway 16).

Optionally and additionally, the filter module 20 may be designed to determine once, for all the runways 16 of the set of runways having the same orientation, the reference frame change operation C and/or calculate each traffic element position T1, T2 in the new reference frame. In other words, this determination of the reference frame change operation C and/or this calculation of the position of each traffic element T1, T2 in the new reference frame, is preferably done only once for all the runways 16 having the same course angle a with respect to the North, modulo 180°.

Optionally and additionally, the filter module 20 may be further designed to carry out an additional preliminary filtering to exclude the acquired traffic information corresponding to traffic elements that are outside the airport domain 12.

The transmission module 24 is designed to transmit, to the electronic display device and/or the on-board avionic system, such as the monitoring device, the identified traffic element(s), so that the identified traffic element(s) is/are displayed, for example, to the pilot of the aircraft or to an operator of a control tower, and/or so that the identified traffic element(s) is/are taken into account by the monitoring device, in particular to avoid a collision of the aircraft with the identified traffic element(s).

The transmission module 24 is furthermore designed to transmit, to the electronic display device and/or the onboard avionic system, information relating to the calculated vicinity 22, for example information relating to the first runway zone ZP and/or the second runway zone ZPP, in order to also display the calculated vicinity 22 and/or show that the monitoring device is aware of the calculated vicinity 22.

The display device is then designed to display traffic elements belonging to the vicinity 22 of a runway 16 in question, wherein this display is preferably parameterizable according to the location of the aircraft and/or according to user settings.

The monitoring device is designed to generate an alert if the risk of collision with an aircraft is detected, in particular if a traffic element has been identified as belonging to the vicinity 22 of a runway 16 on which the aircraft is located, in particular, within the first runway zone ZP and/or the second runway zone ZPP.

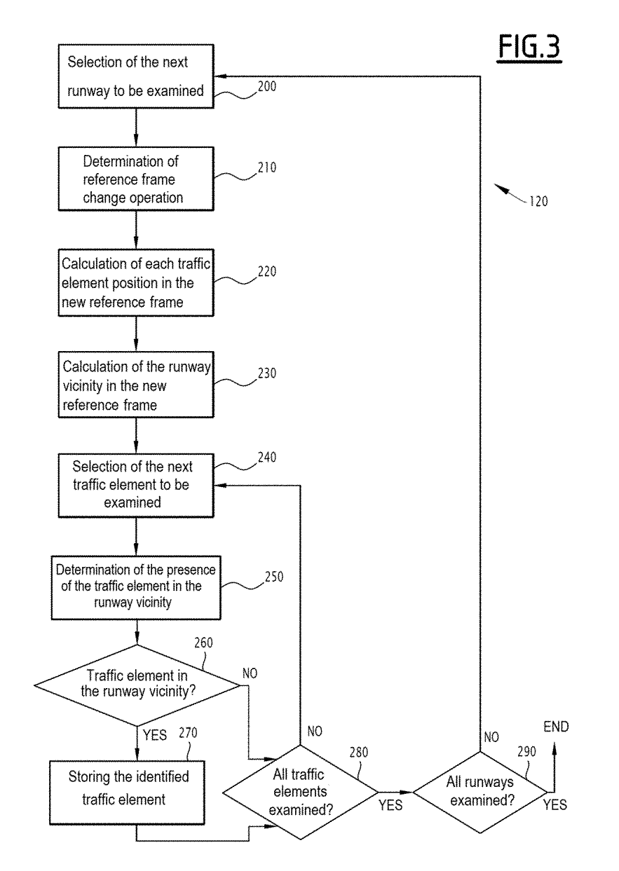

The operation of the electronic filter device 10 according to the invention will now be explained with the aid of FIG. 2 which shows a flowchart of a method according to the invention for filtering traffic information in the airport domain 12, while FIG. 3 shows a more detailed flowchart of the actual filtering of the traffic information.

During an initial step 100, the electronic filter device 10 acquires, via its first acquisition module 14, the runway information for each runway 16 of the set of runways of the airport domain 12. This acquisition 100 is, for example, made from a database of the airport domain 12, as in the example described above of a database that is compliant with the ARINC-816 standard or a database complying with the ARINC-424 standard.

The electronic filter device 10 acquires, during the next step 110 and via its second acquisition module 18, traffic information comprising the position of each traffic element T1, T2 of a set of traffic elements, in particular the position of the traffic elements T1, T2 located inside the airport domain 12. The position of each traffic element T1, T2 is known via an aerial, radar or satellite observation, in particular via such observation from the airport domain 12.

Then, during the next step 120, the electronic filter device 10 filters, via its filter module 20, the acquired traffic information, in particular by identifying each traffic element T2 positioned inside the vicinity 22 of the at least one runway 16 of the set of runways of the airport domain 12. This filter step 120 will be described in more detail below, with reference to FIG. 3 which represents a flowchart of this filter step.

Finally, the electronic filter device 10 transmits, during the next step 130 and via its transmission module 24, the traffic element(s) identified to the electronic display device and/or to the onboard avionic system, such as the monitoring device in order for the identified traffic element(s) to be displayed, for example to the person in question and/or so that the identified traffic element(s) may be taken into account by the monitoring device. Optionally, this transmission step 130 may further comprise transmitting to the electronic display device and/or the onboard avionic system, information relating to the calculated vicinity 22, in order to also display the calculated vicinity 22 and/or so that the monitoring device is aware of the calculated vicinity 22.

The traffic elements are, for example, sent to the display device with the identification for each of them if they belong to a first runway zone ZP or only to a second runway zone ZPP, while not being included in the corresponding first runway zone ZP. The display device then displays, for example, either all the traffic elements, or only the traffic elements belonging to a first runway zone ZP or to a second zone runway ZPP, or only to those belonging to a first runway zone ZP. This display mode is, for example, left to the initiative of the user or as a function of the location criteria (aircraft close or not to a runway, approach, takeoff) or display (zoom level, centering of the map).

In addition, this information of affiliation to a first runway zone ZP or to a second runway zone ZPP is associated with different respective symbols, for example by making the traffic elements affiliated with a first ZP runway zone, more visible.

Alternatively or additionally, the traffic elements and the information of their belonging to a runway vicinity 22, such as a first runway zone ZP or a second runway zone ZPP, are sent to the monitoring device so that appropriate alert levels may be developed based on the risk of collisions with these traffic elements. In fact, the alert level is generally dependent on the affiliation or proximity of the traffic element to a corresponding runway 16.

In FIG. 3, the filter step 120 firstly comprises the selection 200 of the next runway 16 to be examined, wherein the runways 16 are preferably examined successively one by one by the filter module 20.

Those skilled in the art will nevertheless observe that the filter step 120 may be optimized, especially in terms of computation time, by grouping together all the runways 16 which have the same orientation, since the same reference frame change operation C is applicable to each of them. The grouped runways 16 are then those for which the course angle is the same, modulo 180°, wherein two different course angles of 180° correspond to the same direction in the opposite sense.

The filter module 20 then performs the determination 210, for the respective runway 16 or for the group of runways 16, of the reference frame change operation C to be applied to each traffic element position T1, T2 in order to pass from the current reference frame R′ to the new reference frame R, for example by using the above equations (1) and (2).

The filter step 120 then comprises the calculation 220, by the filter module 20, of each traffic element position T1, T2 in the new reference frame R, by applying, for example, the preceding equations (1) and (2), to the coordinates of the position of each traffic element T1, T2 in the current reference frame R′.

The filter step 120 also comprises the calculation 230, by the filter module 20, of the runway vicinity 22 in the new reference frame R, as previously described, for example from the position of the runway threshold in the new reference frame R.

Those skilled in the art will note that, during the filter step 120, the order in which the calculation 220 of each traffic element position in the new reference frame R is performed, and the calculation 230 of the runway vicinity 22 in the new reference frame R is without importance, wherein the calculation 220 is performed before or after the calculation 230.

The filter module 20 then makes the selection 240 of the next traffic element to be examined, then the determination 250 of the presence or absence of the traffic element in the runway vicinity 22 in the new reference frame R, wherein this is effected by simply comparing in the new reference frame R, the coordinates (x_{T1}; y_{T1}), (x_{T2}; y_{T2}) of each traffic element T1, T2 with the abscissa and ordinate of the boundaries of the calculated runway vicinity 22.

In the next test 260, the filter module 20 then determines whether or not the examined traffic element T1, T2 belongs to a runway vicinity 22, and in the case that it belongs to a runway vicinity 22, it performs the storage 270 of the identified traffic element, for example in the memory 32, for the subsequent transmission of the identified traffic element. Alternatively, all the traffic elements T1, T2 may be stored in the memory 32 with a view to their subsequent transmission, and the identified traffic element(s) T2 is/are then referenced with an attribute that is characteristic of their belonging to a first runway zone ZP, or to a respective second runway zone ZPP.

If the test 260 is negative, i.e. if the traffic element T1, T2 examined does not belong to any runway vicinity 22, the filter module 20 passes to the test 280 to determine whether all the traffic elements have been examined. If so, it passes to the next test 290 to determine whether all the runways 16 have been examined, and, if not, the filter module 20 returns to selection 240 to proceed to the next traffic element to be examined.

In test 290, if all the runways 16 have been examined, then the filter step 120 is over, otherwise the filter module 20 returns to selection 200 to proceed to the next runway 16 to be examined.

Thus, the electronic filter device 10 and the filter method according to the invention make it possible to simply identify the traffic elements belonging to a runway vicinity 22, in particular to a first runway zone ZP that substantially corresponds to the respective runway 16, or a second runway zone ZPP that corresponds to an area close to the runway 16, whatever the orientation of this runway 16 while minimizing the necessary computing resources.

For example, with 1 traffic element for each runway of the airport and 20 traffic elements in the terminal area (i.e. off-runway and runway proximity), more than 5000 calculation operations would be required using the prior art filter method to determine which traffic elements belong to the vicinity of the runways 16, while with the filter method according to the invention, less than 1100 operations are necessary to achieve this result.

The electronic filter device 10 and the filter method according to the invention therefore allow a relevant display of airport traffic on an airport map, identification of airport traffic in a danger zone, and/or implementation of a monitoring and alert activation function with respect to the risk of collision, while requiring few computation resources. The filter method according to the invention is then able to be implemented on an onboard avionic computer, without requiring all of its resources and without compromising its ability to accept additional future features.

It is thus conceivable that the electronic filter device 10 and the filter method according to the invention are more efficient, especially in terms of computing resources.

1. Method of filtering traffic information in an airport domain, wherein the method is implemented by an electronic device and comprises:
runway information acquisition for each runway of a set of runways of the airport domain;
traffic information acquisition, wherein the traffic information comprises the position of each traffic element of a set of traffic elements; and
filtering of the acquired traffic information, wherein the filtering comprises the identification of each traffic element positioned inside the vicinity of at least one runway of all the runways,
wherein the filtering includes, for each runway of the set of runways:
determination of a reference frame change operation, a change from a current reference frame to a new reference frame, wherein the respective runway is oriented in a vertical or horizontal direction in the new reference frame,
calculation of the runway vicinity in the new reference frame via the determined reference frame change operation,
calculation of each traffic element position in the new reference frame via the determined reference frame change operation, and
comparison, in the new reference frame, of each traffic element position calculated with the calculated runway vicinity, for identifying each traffic element positioned within the vicinity of the respective runway.

2. Method according to claim 1, wherein the determined reference frame change operation is a rotational operation with a rotation angle as a function of an orientation of the respective runway.

3. Method according to claim 2, wherein the absolute value of the angle of rotation is equal, modulo 90°, to a course angle relative to the North of the respective runway.

4. Method according to claim 1, wherein each runway of the set of runways of the airport domain has a runway threshold, and the calculation of the runway vicinity in the new reference frame comprises the calculation of the position of the runway threshold in the new reference frame via the determined reference frame change operation, wherein the runway vicinity is calculated from the position of the runway threshold in the new reference frame.

5. Method according to claim 1, wherein each runway vicinity has a first rectangular runway zone.

6. Method according to claim 5 wherein each runway vicinity has a second rectangular runway zone, wherein the second runway zone comprises the first runway zone for the respective runway, wherein each side of the second runway area is substantially parallel to a corresponding side of the first runway area.

7. Method according to claim 1, wherein determining of a reference frame change operation and/or computing each traffic element position in the new reference frame are performed only once for all runways of the set of runways having the same orientation.

8. Method according to claim 1, wherein the method further comprises the transmission to an electronic display device and/or to an onboard avionic system, of such as a monitoring device, the identified traffic element(s).

9. Non-transitory computer-readable medium including a Computer program comprising software instructions which, when implemented by a computer, implement a method according to claim 1.

10. Electronic device for filtering traffic information in an airport domain, wherein the electronic device comprises:
a first acquisition module that is designed to acquire runway information for each runway of a set of runways of the airport domain;
a second acquisition module that is designed to acquire traffic information, wherein the traffic information comprises the position of each traffic element of a set of traffic elements; and
a filter module that is designed to filter the acquired traffic information, wherein the filter module is designed to identify each traffic element located within a vicinity of at least one runway of the set of runways,
wherein the filter module is, for each runway of the set of runways, designed to:
determine a reference frame change operation from a current reference frame to a new reference frame, wherein the respective runway is oriented in a vertical or horizontal direction in the new reference frame,
calculate the runway vicinity in the new reference frame via the determined reference frame change operation,
calculate each traffic element position in the new reference frame via the determined reference frame change operation, and
compare, in the new reference frame, the position of each traffic element calculated with the calculated runway vicinity, for the identification of each traffic element positioned within the vicinity of the respective runway.
